(19) United States
(12) Patent Application Publication
(10) Pub. No.: US 2006/0095371 A1
(43) Pub. Date: May 4, 2006

(54) Strategic payment allocation system

(76) Inventor: Nixon Jean-Baptiste, Brooklyn, NY (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/977,358

(22) Filed: Oct. 29, 2004

(51) Int. Cl. G06Q 40/00

(52) U.S. Cl. 705/40

(57) ABSTRACT

The present invention is directed to a method for managing and paying off a plurality of loan debts comprising the following debts a) Identifying the debts with the highest periodic interest expense; b) determining an extra payment value to be placed; c) making a payment of the debt with the extra payment to be paid on the debt with the highest periodic interest payment; d) paying off the payment with the highest periodic interest payment; and e) paying the payment on the first debt and the extra payment on the debt with second highest periodic interest payment.

### FIELD OF THE INVENTION

The present invention is directed to a strategic payment allocation module, which may be used in financial planning for early repayment of all interest-bearing amortizing debt accounts.

### BACKGROUND OF THE INVENTION

Millions of people throughout the United States and Canada have serious debt problems. Millions of consumers hold various forms of consumer debt. This debt ranges from high interest on credit cards, to installment loans on large appliances, cars and home improvements. Very few people have contemplated the substantial expense associated with this debt, particularly the effect of high interest rates. Many consumers are content to pay minimums on credit cards. At interest rates of 18% to 25%, most consumers are kept in debt for decades.

The patent literature has provided a number of systems for facilitating payment and debt allocation. A number of patents have issued relating to method for an automated debt payment system and method utilizing ATM networks. U.S. Pat. No. 6,304,860, which discloses an automated debt payment system and method using ATM network.

U.S. Pat. No. 6,304,860, to Martin, Jr., et al., has an issue date of Oct. 16, 2001. The patent is directed towards an electronic funds transfer methodology for providing access to a plurality of non-bank loan payment processors (loan servicers) through established ATM (automated teller machine) networks, thereby creating a payment system designed to allow a consumer to initiate an electronic transfer of funds from a primary bank transaction account (e.g., checking account, savings account) to a loan servicer to satisfy an outstanding consumer debt or payment obligation. Automated payment of consumer debt obligations through use of an ATM network is facilitated by a processor and associated software, which are employed to combine specific consumer loan payment data with specific depository transaction account information through an electronic ATM network for the purpose of affecting a more efficient loan payment/servicing process. Information relevant to the loan payment is electronically communicated from the loan servicer through software designed to access the servicer's loan database, extract specific fields from designated records, and communicate this information to a third party central computer. The third party central computer reformats the data as necessary, aggregates this information with any similar information received from other loan or debt servicers, and transmits the aggregated information to one or more ATM transaction processors.

U.S. Patent Publication No. 2002/0138409, to Bass, has a publication date of Sep. 26, 2002. The invention is directed towards methods and systems for offering debt recovery products to customers having delinquent accounts are disclosed. A debt recovery service retrieves delinquent account information corresponding to a customer. Based on the retrieved delinquent account information, the debt recovery service determines a set of debt recovery offers for the customer. The customer sends customer selection information to the debt recovery service. Customer selection information customizes a debt recovery product that corresponds to one of the set of debt recovery offers. The debt recovery service then creates a debt recovery account for the customized debt recovery product.

U.S. Pat. No. 6,654,727, to Tilton, has an issue date of Nov. 25, 2003. The patent is directed towards a platform and a securitization methodology that provides lenders with an opportunity to maximize the returns on their distressed commercial credit facilities and overcomes the obstacles that have historically precluded the securitization of distressed commercial loans. The present invention is based upon an underlying portfolio of at least 30% distressed commercial loans for securitization that emulates the predictability and regularity of the cash flow and recovery characteristics of a portfolio of generally performing commercial loans, thus eliminating crucial historical barriers to securitization of such distressed commercial loans, such as the absence of predictable and regular cash flows and predictable recoveries. The methodology of the present invention takes a specified mix of distinct classifications of distressed commercial loans with specified characteristics in confluence with structural specifications, such as specific reserves and safeguards, to create a synthetic asset class that emulates the characteristics of a portfolio of performing loans.

U.S. Pat. No. 5,852,811, to Atkins, has an issue date of Dec. 22, 1998. The patent is directed towards a personal financial program which discloses an incorporating means of implementing, coordinating, supervising, planning, analyzing and reporting upon investments in an array of asset accounts and liability accounts within a client account. Through a prioritization function, the client specifies his financial objectives, his risk preference, a forecast of economic and financial variables, and budgetary constraints. The prioritization function suggests to the client a portfolio of asset and liability accounts that may be credited and debited to form investments and borrowings to best realize his financial objectives over a defined time horizon. In the preferred embodiment a central structural element of the financial account is a liability account secured by the client's home and one or more asset accounts. Client funds that would normally be used to amortize the mortgage may be alternatively used according to a prioritized allocation of funds to asset accounts and liability accounts. The client account is imbalanced if the client's borrowing power is less than the minimum borrowing power specified by the financial institution. If the account is imbalanced, the client may reallocate the assets and liabilities within the client account and/or modify a set of constraints on the client account. If the client account is still not balanced after modification of the account, the system initiates a liquidation procedure.

Japanese Patent No. JP 20033108763, to Three F Online KK, has a publication date of Apr. 11, 2003. The patent is directed towards providing a financial system capable of relaying loan application procedures and debt repayment procedures via an operation terminal installed in a convenience store, etc. The financial service system is characterized in that the operation terminal is connected with a plurality of banking facilities via a network by a computer system, the operation terminal is provided with an application accepting means for performing procedures for loan application, a repayment accepting means for performing repayment procedures of the debt and a contents accepting means for receiving added value contents, user information inputted in the operation terminal by the application accepting means is transmitted to a banking facility that accepts the application from the operation terminal, repayment information inputted in the operation terminal by the repayment accepting means is transmitted to a banking facility that receives the repayment from the operation terminal, simultaneously transmitted to a POS (point of sale) register of a store that manages the operation terminal and a receipt is issued after a money deposit processing is performed by the POS register and collation of transaction between the operation terminal and the POS register is performed.

None of the prior art has been directed to a system, which enables consumers to more able manage debt pay off. Such a system would enable consumers to more effectively handle debt pay off and to build equity and nest eggs.

### OBJECTS AND SUMMARY OF THE INVENTION

It is an object of the present invention to provide a system for enabling debtors to more rapidly pay off debt.

It is a further object of the present invention to provide a system in which consumer debt can be paid down according to the interest rates of the debt items.

It is a further object of the present invention to provide a system in which consumer debt can be paid down according to the term of the debt items.

It is a further object of the present invention to provide a system in which debt is paid off based upon the periodic size of the individual debt items.

It is a further object of the present invention to provide a system in which the debt with the largest interest rate is paid off first.

It is a further object of the present invention to provide a system in which debt is paid off based upon the interest expense of the debt items.

It is a further object of the present invention to provide a vehicle whereby payment can be used for investment.

These and other objects of the invention will become apparent from the detailed description, which follows.

The present invention provides a novel debt repayment system. The invention groups all amortizing debt accounts as a portfolio. It computes the initial minimum periodic total cash flow and may maintain that amount in schedule until the last debt is paid off. Whenever additional amounts of money are added to the portfolio or become available by paying off any of the creditors, the invention identifies the creditor of the highest periodic interest expense payment to increase the periodic payment respectively.

The invention is directed towards the highest periodic interest expense debt account elimination strategy, a method whereby the creditor with the highest periodic interest expense is paid off first, and then the amount which becomes available may be used to pay off the next periodic interest expense account, etc. When put in an investment prospective whereby the debtor maintains the minimum scheduled repayment amount and invests for a return any amount of money, which becomes available. The invention offers an earlier repayment of all debts and a larger future value based on a specific rate of return.

The invention determines the economic savings, which is the difference between the total scheduled repayment amount and the total actual repayment amount, for each alternative repayment method. In addition, the invention compares the return on investment for each method.

### BRIEF DESCRIPTION OF THE FIGURES

FIG. 1 is a flow chart of the first embodiment of the invention.

FIG. 2 is a flow chart of the second embodiment of the invention.

FIG. 3 is a diagram of yet another embodiment.

FIG. 4 is a diagram of a third embodiment of the invention, which illustrates the allocation of payments subject to the size of the interest payment.

### DETAILED DESCRIPTION OF THE INVENTION

The present invention is described with reference to the enclosed figures wherein the same numerals are used. In a most preferred embodiment, the invention is a system and method for paying off a plurality of debts, specifically, debts with a shorter term to maturity, highest interest rate, and/or high balance, highest interest expense.

In a most preferred embodiment, the invention is directed to more rapidly paying off a plurality of consumer or business debt items such as installment and revolving debt. In one embodiment, the consumer pays off a pre-set amount in excess of the minimum or monthly payment required.

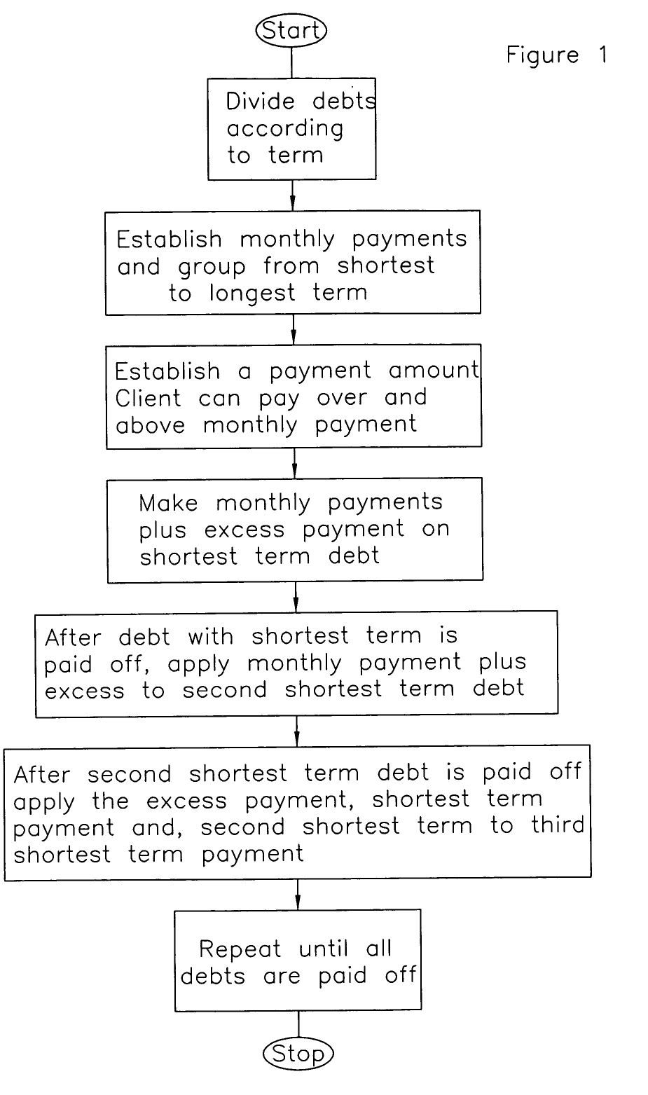

Referring to FIG. 1, the initial embodiment is based upon categorizing payments according the length of the payment term, i.e., whether the debt or loan is 24, 48, 60 months of longer. The debt with the shortest payoff term is set in the first position sequentially and the debts with longer payoff terms are then set forth in ascending sequence. The debtor may determine an additional monthly amount (the excess amount), which can be paid. It is assumed that the total monthly debt of the consumer plus the additional excess amount can be paid throughout the full term of all the debts.

Initially, the additional excess amount is used to pay off the shortest-term debt. With the addition of the excess amount, paid monthly, the payoff of the shortest-term debt is accelerated. After the payoff of the shortest term debt, the excess amount, which may include the payment of paid off accounts, plus the amount of the monthly payment of the shortest term debt is then used to pay off the second shortest term debt. The additional payments from the excess and shortest-term debt accelerate the payment schedule of the second shortest-term debt. After the second shortest term debt is paid off, the excess, shortest term and second shortest term debts may be applied to the third shortest-term debt. This process repeats until all debts are paid off.

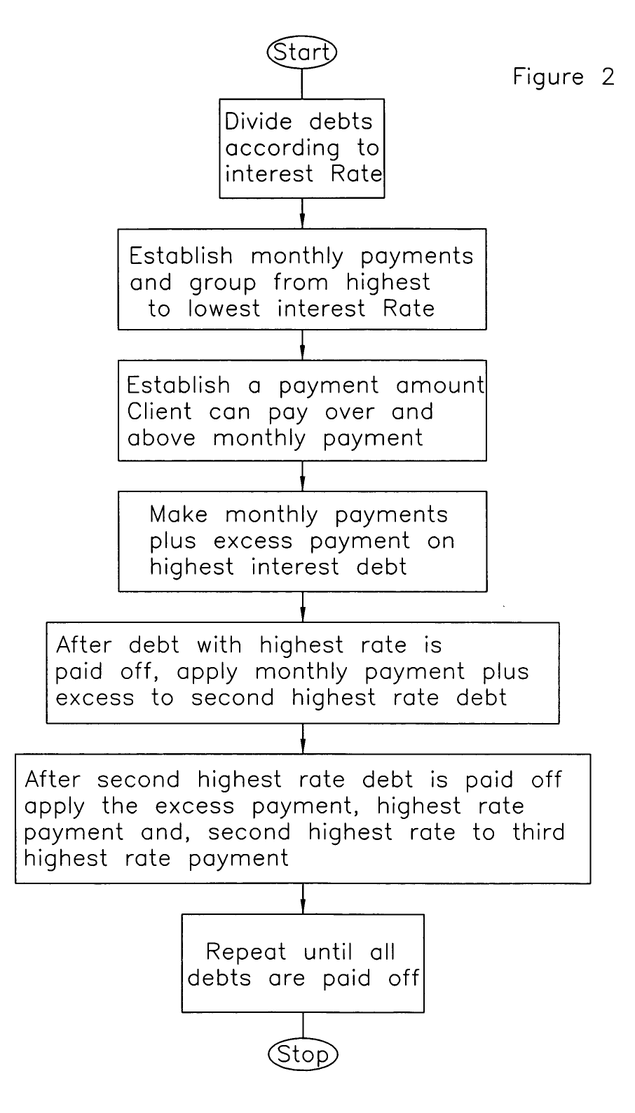

Referring to FIG. 2, in a second embodiment, the priority is given to the highest interest rate of the debts. Here the additional excess amount is used to pay off the highest interest rate debt. With the addition of the excess amount, paid monthly, the payoff of the highest interest rate debt is accelerated. After the payoff of the highest interest rate debt, the excess amount, plus the amount of the monthly payment of the next highest interest rate debt is then used to pay off the second highest interest rate debt. The excess, which may include the payment of paid off accounts, plus the payment schedule of the second highest interest rate debt is then used to pay off the second highest interest rate debt. After the second highest interest rate debt is paid off, the excess, which may include the payment of paid off accounts plus the payment schedule of the next highest interest rate debt may be applied to the third highest interest rate debt. This process repeats until all debts are paid off.

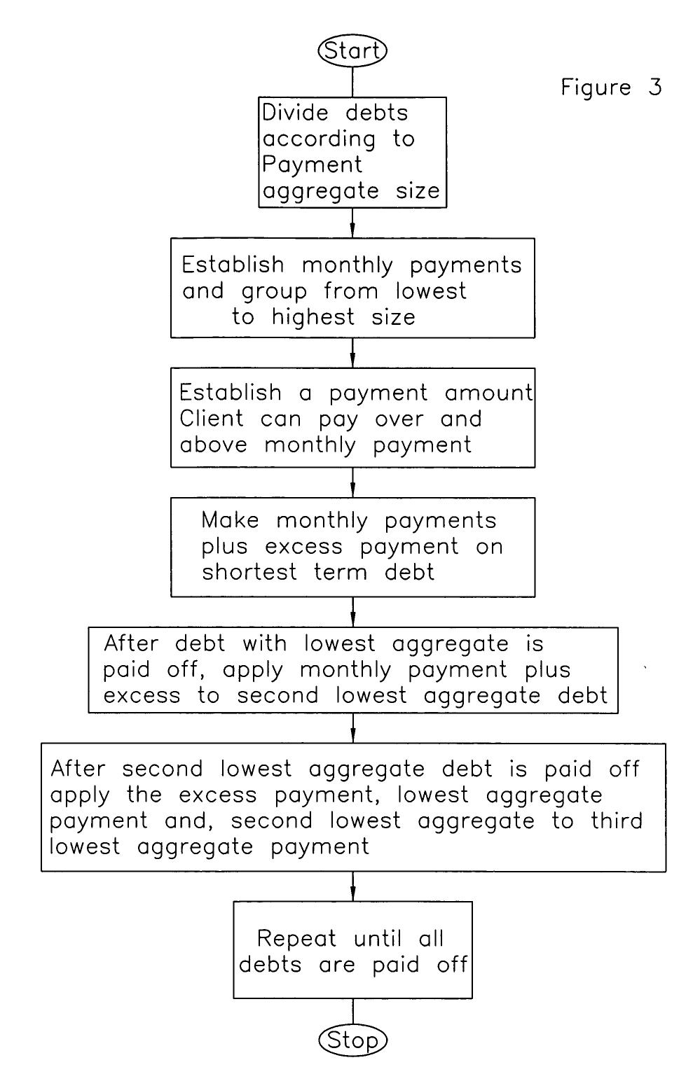

In a third embodiment of FIG. 3, the priority is given to the largest-aggregate periodic balance. Here, the system identifies the largest aggregate balance for the period; the additional excess amount is used to pay off the largest aggregate balance debt. With the addition of the excess amount, paid monthly, the payoff of the largest aggregate balance debt is accelerated. After the payoff of the largest aggregate balance debt, the excess amount, which may include the payment of paid off accounts, plus the amount of the monthly payment of the next largest aggregate balance debt is then used to pay off the second largest aggregate balance debt. After the payoff of the second largest aggregate balance debt, the excess amount, which may include the payment of paid off accounts, plus the amount of the monthly payment of the next largest aggregate balance debt is then used to pay off the third largest aggregate balance debt. This process repeats until all debts are paid off.

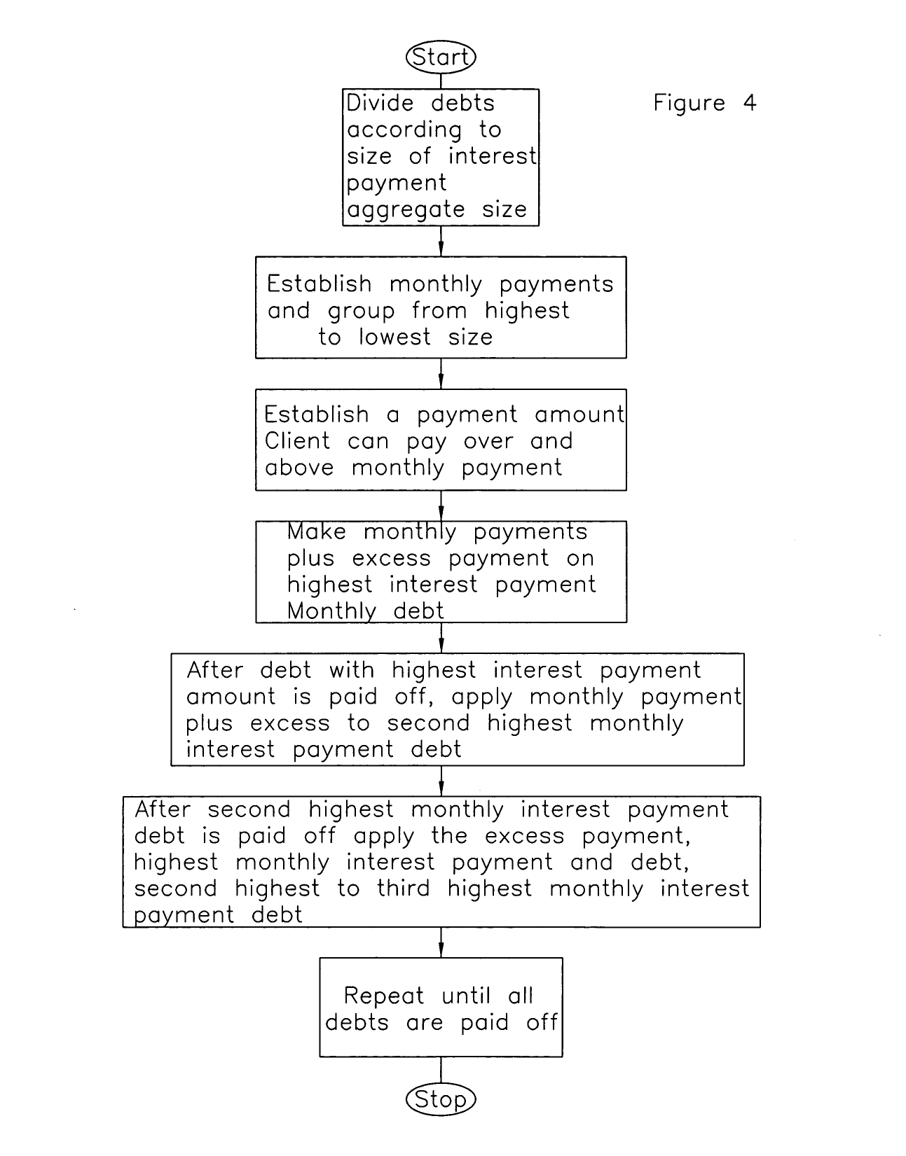

In a fourth embodiment of FIG. 4, the priority is given to the highest periodic interest expense amount, which is the interest rate multiply by the balance, multiple by the number of days, divided by the total business days in a calendar year. The system identifies the highest interest expense amount for each period. Here the additional excess amount is used to pay off the highest interest expense debt. With the addition of the excess amount, paid monthly, the payoff of the highest interest expense debt is accelerated. After the payoff of the highest periodic interest expense debt, the excess amount, which may include the payment of paid off accounts, plus the amount of the monthly payment of the next highest interest expense debt is then used to pay off the second highest interest expense debt. After the payoff of the second highest interest expense debt, the excess amount, which may include the payment of paid off accounts, plus the amount of the monthly payment of the next highest interest expense debt is then used to pay off the third highest interest expense debt. This process repeats until all debts are paid off.

As can be seen, the present invention suggests a plurality of permutations. In general, the invention can group all amortizing debt accounts as a portfolio. It computes the initial minimum periodic total cash flow and may maintain that amount in schedule until the last debt is paid off. Whenever additional amounts of money are added to the portfolio or become available by paying off any of the creditors, the invention identifies the creditor to be paid next and increase the periodic payment respectively.

This feature of the invention helps determine the most optimal method for paying off the debts based on the largest amount of economic savings, which is the different between the total scheduled repayment and the total actual repayment of the portfolio, for each method.

Investment features can be applied to determine the most optimal method of paying off the debts that would produce the highest investment return. As additional monies become available when each debt is paid off, the system considers the possible return on investment for each method.

In the first embodiment where the priority was given to the shortest-term debt, after paying off the last debt the excess amount used in the portfolio is considered for investment until the maximum scheduled term of the portfolio.

In the second embodiment where the priority was given to the highest interest rate of the debts, after paying off the last debt the excess amount used in the portfolio is considered for investment until the maximum scheduled term of the portfolio.

In the third embodiment where the priority was given to the aggregate periodic balance debt, after paying off the last debt the excess amount used in the portfolio is considered for investment until the maximum scheduled term of the portfolio.

In the fourth embodiment where the priority was given to the highest interest expense debt, after paying off the last debt the excess amount used in the portfolio is considered for investment until the maximum scheduled term of the portfolio.

These methods are weighted against each other and against the investment return of a situation where no excess amount was applied to pay off debt. The feature help to consider the most optimal method that would produce the highest investment return when paying off debts is a consideration.

The present invention has been described with reference to the enclosed detailed description, the true nature and scope of the invention is to be determined with reference to the attached claims. These and other features of the present invention will become apparent from the claims attached hereto.

1. A method for managing and paying off a plurality of loan debts comprising the following debts:
a) placing the debts in a descending order according to their pay off period;
b) determining an extra payment value to be placed;
c) making a payment of the debt with the extra payment to be paid on the debt with the shortest term;
d) paying off the debt with the shortest term; and
e) applying the payment for the first debt and the extra payment on the debt with second shortest term.

2. A method for managing and paying off a plurality of debts comprising the following steps:
a) placing the debts in descending order according to their interest rates;
b) making a payment on the debts and adding a supplemental payment on the debt with the highest interest rate so as to pay off that debt first;
c) making a payment on the next highest debt according to interest rates and applying the supplemental payment and payment for the debt with the highest interest rate; and
d) repeating steps (a) through (c) until all debts are paid off.

3. A method for managing and paying off a plurality of debts comprising the following steps:
a) placing the debts in an according to their periodic aggregate amounts;
b) making a payment on the debts and adding a supplemental payment on the debt with largest periodic aggregate amount rate so as to pay off that debt first;
c) making a payment on the next largest periodic aggregate debt and applying the supplemental payment and payment from the largest periodic aggregate debt; and
d) repeating steps (b) through (c) until all debts are paid off.

4. A method for managing and paying off a plurality of debts comprising the following steps:
a) placing the debts in an according to their periodic interest expense amounts;
b) making a payment on the debts and adding a supplemental payment on the debt with highest periodic interest expense amount so as to pay off that debt first;
c) making a payment on the next highest interest expense debt and applying the supplemental payment and payment from the highest periodic interest expense debt; and
d) repeating steps (b) through (c) until all debts are paid off.
